(19) United States
(12) Patent Application Publication
(10) Pub. No.: US 2006/0007449 A1
(43) Pub. Date: Jan. 12, 2006

(54) Method for measuring a contour of a workpiece by scanning

(76) Inventors: Ralf Christoph, Giessen (DE); Klaus Mueller, Essen (DE); Wolfgang Rauh, Waldenbuch (DE)

Correspondence Address: DENNISON, SCHULTZ, DOUGHERTY & MACDONALD, 1727 KING STREET, SUITE 105, ALEXANDRIA, VA, 22314, US

(21) Appl. No.: 10/538,836

(22) PCT Filed: Dec. 15, 2003
(86) PCT No.: PCT/EP03/14252

§ 371 Date: Jul. 12, 2005

(30) Foreign Application Priority Data
Dec. 13, 2002 (DE) 102 58 685.3
Apr. 7, 2003 (DE) 103 15 990.8

(51) Int. Cl. G01B 5/20; G01B 5/008

(52) U.S. Cl. 356/601; 33/503; 33/556

(57) ABSTRACT

A method for measuring a contour of a workpiece by scanning, using first and second sensors. According to the invention, the contour of the workpiece may be measured with high precision and rapidly, especially in the edge region, the contour of the workpiece being recorded by means of the at least two sensors and the information obtained from at least one sensor is used to influence the actions of at least one other sensor.

The invention relates to a method for measuring and/or capturing a contour and/or geometry of a workpiece by scanning while employing a first and a second sensor.

Capturing contours for the purpose of measuring workpiece geometries is a typical function of coordinate measuring devices. It is based on the problem that contours of workpieces are supposed to be compared to target contours and/or be used for controlling machine tools to duplicate parts. It is likewise required for comparing in this way master parts to additionally manufactured parts. Currently, methods are used employing so-called measuring feeler systems in which a feeler passes over the searched workpiece contour continuously or gradually, and this way measuring points are captured. The disadvantage of the method is that filigree contours can be scanned only to a limited extent due to the relatively large size of the feeler elements that is required. We, furthermore, know of methods in which contours are scanned using a light transmission or incident light method by means of opto-electronic image processing. The disadvantage of these methods is that only the respectively upper edges of contours can be measured, not, however, for example, the contour in the center of the flank of an object such as a gear wheel.

For the purpose of measuring filigree 3D objects, tactile optical feelers are known, as those disclosed in EP 0 988 505. Based on the working principle, extremely small feeler configurations can be implemented in this way. The use of such feelers for scanning methods is not always possible in an optimal fashion due to the flexible behavior of the feeler pins. Controlling the process of tracing the part contour, which is required for scanning, is difficult to implement due to the erratic measuring results of the micro-feelers (e.g., due to stick-slip effects).

From the special publication “Kontrolle (Control) May 1994”, Werth Messtechnik GmbH, Gieβen, we know of a photo-electronic contour scanning method, in which a CCD camera is used, allowing several thousand measuring points to be recorded per scanning process.

It is the object of the present invention to further develop a method of the above-mentioned kind, such that the contour of an object, especially also in the flank area, can be measured with a high level of precision and speed.

From WO 03/008905 A1, we know of a coordinate measuring device, in which by means of an optical sensor the movement of a tactile optical fiber feeler is determined.

The object is essentially achieved in that the contour and/or geometry of the workpiece is captured with the aid of at least two sensors and that information obtained from at least one sensor is used to influence another sensor in its actions. Here at least one sensor can be an image processing sensor. It is also possible to use a feeler measuring upon contact as at least one sensor. Pursuant to another suggestion, it is provided that at least one sensor is used as a touchless distance sensor. A fiber-optic feeler can also be one of the sensors in question.

Furthermore, it is provided that at least one of the sensors is used to position at least one other sensor within its working area.

Furthermore, at least one of the sensors can be used to prevent a collision of further involved sensors.

When using an image processing sensor, different illumination arrangements can be used, such as incident light or transmitted light.

Preferred embodiments provide that, with the use of a tactile-optically operating feeler—also referred to as an opto-tactile feeler—with a feeler element, the scanning direction required for a feeler element correction is generated from information of another sensor, and/or that the scanning direction of one or the contact sensor required for the feeler element is generated from information of another sensor.

Pursuant to an embodiment of the invention, at least one image processing sensor is focused on the basis of a measuring reading determined with a distance sensor.

An image processing sensor can be focused on the basis of a measuring reading determined with a contact feeler. Pursuant to another suggestion, a scanning operation is performed within one step, with processing of the sensor information taking place on-line. Alternatively, the scanning process can occur in several individual steps, wherein processing of the sensor information does not occur in line with scanning.

The invention is also characterized in that first a contour in a plane is scanned with one sensor, and a third coordinate to the contour and/or plane or a contour offset thereto is captured with a different sensor, wherein the measuring points of the first contour define travel paths.

Additionally, a scanning plane can be defined a priori and a distance sensor can be displaced, such in the plane that the distance value is a constant, wherein the method is not performed in the direction of the axis of the sensor.

The scanning operations as such can be performed on one or more coordinate measuring devices.

When using an image processing sensor as one of the sensors, one should be used where the magnification can be modified.

In particular, a combination of sensors is used, such as image processing with laser (distance measuring system) and/or image processing with contact feeler and/or image processing with fiber feeler and/or opto-tactile feeler and/or image processing with image processing in various resolutions and/or image processing with various views and/or image processing with different illumination types/adjustments and/or laser with contact feeler and/or laser with fiber feeler such as opto-tactile feeler and/or contact feeler with fiber feeler such as opto-tactile feeler and/or contact feeler with contact feeler with various feeler elements or sensitivity levels and/or fiber feeler with fiber feeler with various feeler elements or sensitivity levels.

Pursuant to the invention, the problem is essentially solved in that the contour is measured by means of a feeler and an optical sensor assigned thereto in an opto-tactile manner, and that the feeler is controlled in terms of its movements along the contour by means of an image processing sensor.

Pursuant to the invention, a method is described for implementing a scanning process using e.g., opto-tactile micro-feelers in that for the actual scanning motion, i.e., for the movement of the feelers, the processes of an image processing scanner are employed. In this way, the contour of the object that is to be measured is tracked by means of image processing scanning. The actual measuring points are realized with simultaneous and/or subsequently following measurements using one or more opto-tactile feelers or purely measuring and/or switching feelers. Thus, the advantages of continuous image processing scanning can be combined with the advantages of being able to measure flanks on measurement objects by means especially of opto-tactile feelers for filigree structures.

In particular, the method is implemented on a coordinate measuring device, wherein the regulation or control of the scanning operation of the coordinate measuring device will be realized via the image processing sensor and the capturing of the measuring points via a feeler, in particular an opto-tactile sensor.

In a preferred embodiment, the same image processing optics, camera and electronics are used for tracing the contour with the image processing sensor and for measuring the measuring points with the opto-tactile sensor.

Furthermore, it is possible to use a separate optical beam path for tracing the contour with the image processing sensor.

Moreover, the image processing sensor and the opto-tactile sensor can be integrated in an optical path in such a way that adjusted different magnification levels are achieved for both sensors.

Tracing the contour with the image processing sensor can occur with transmitted light or incident light, wherein at the same time measurement takes place with the opto-tactile sensor alternatively in the transmitted or incident light mode.

To the extent that a feeler with a spherical feeler element is used, the scanning direction of the opto-tactile feeler required for the feeler sphere correction can be generated from image processing contour tracing.

Additionally, the image processing windows used for contour tracing can overlap. Contour tracing can be performed with an image processing scanner and occur at a previously defined distance to the contour traced in this way, with another distance sensor at the height of the measurement object.

The image processing sensors as themselves can be focused on the basis of a measuring reading determined with a distance sensor, wherein a laser distance sensor can be used as the distance sensor, which in turn can be integrated in the optical path of the image processing sensor, if required.

In particular, it is provided that first a contour in a plane is scanned using a sensor, and then the third coordinate to said contour (plane) or a contour offset thereto is scanned using another sensor, wherein the measuring points of the first contour define the travel paths.

Additionally, a scanning plane can be defined in advance in workpiece coordinates, and the distance sensor can be displaced in said plane such that the distance value is a constant, wherein the method is not performed in the direction of the axis of the sensor.

Further details, benefits and features of the invention result not only from the claims, the features disclosed therein—either alone and/or in combination—, but also from the following description of a preferred embodiment revealed in the drawing.

Shown are:

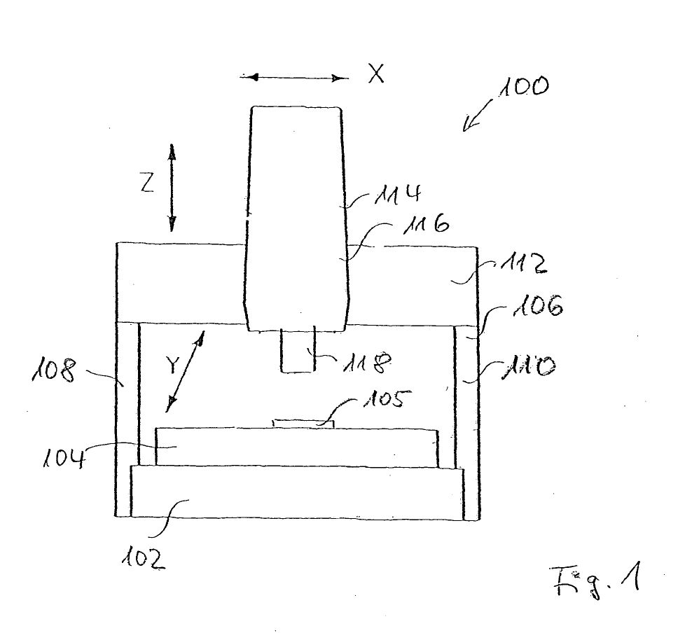

FIG. 1 a representative illustration of a coordinate measuring device,

FIG. 2 a representative illustration of a first embodiment for measuring a contour of an object,

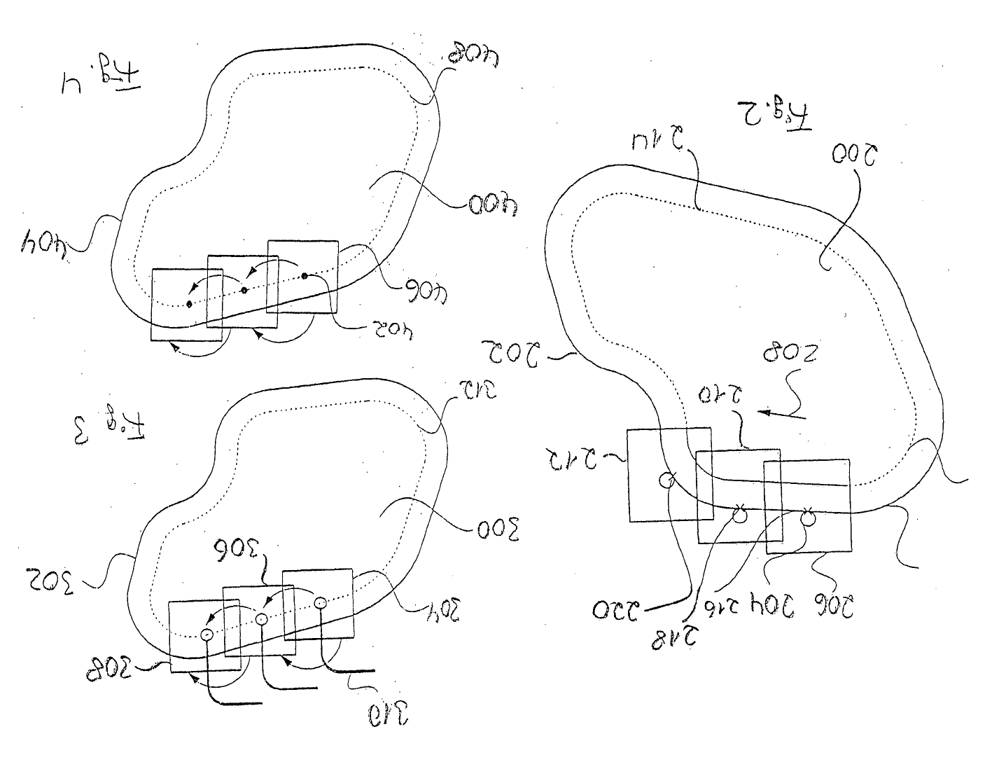

FIG. 3 a representative illustration of a second embodiment for measuring a contour of an object, and

FIG. 4 a representative illustration of a third embodiment for measuring a contour of an object.

FIG. 1 shows the principle of a coordinate measuring device 100 with a base frame 102 consisting, e.g., of granite. On it a measuring table 104 is arranged, on which a workpiece 105 is located, which is supposed to be measured.

Along the base frame 102, a portal 106 is arranged adjustably in the Y-direction of the coordinate measuring device 100. For this, columns or stands 108, 110 are supported on the base frame in a sliding fashion. From the columns 108, 110 a cross-beam 112 extends, along which, in the exemplary embodiment in the X-direction of the coordinate measuring device 100, a carriage 114 is arranged adjustably, which in turn holds a sleeve or column 116, which can be adjusted in the Z-axis direction. From the sleeve or column 116 or an interface provided there, at least two sensors extend in order to measure the contour and/or geometry of the workpiece 105 arranged on the measuring table 104. It can involve, e.g., a sheet metal board.

FIG. 2 shows in principle a sheet metal board 200 as the workpiece, the contour 202 of which is scanned using a sensory system combination consisting of an opto-tactile feeler and an image processing sensor, the measurement field of which is symbolized by rectangles 206.

Tracing of the workpiece contour 202 occurs in a scanning direction 208 by stringing several image processing positions together (rectangles 206, 210, 212), which are being determined from the course of the contour in the respectively current image processing window. In the exemplary embodiment, a contour 214 is scanned in incident light parallel to the contour 202 that is to be measured. At the same time the measuring points 216, 218, 220 are recorded using the opto-tactile feeler 204 on the contour 202 that is to be measured. Opto-tactile measuring is performed in a manner as is revealed, e.g., in EP 0 988 505 B1, to the disclosure of which express reference is made here. Pursuant to the invention, the movement of the opto-tactile sensor 204 is established by the contour data determined during image processing.

In FIG. 3, the inventive method is implemented through a combination of tactile and optical scanners with image processing and mechanical sensing system. As the workpiece, again a sheet metal board 300 is selected, the contour 302 of which is scanned by stringing several images 304, 306, 308 together using an image processing sensor. The contour obtained in this way allows a conclusion of the outer shape of the sheet metal board 300. At an offset from the outer edge, which the operator can define beforehand, the course of elevations of the sheet metal board 300 is then measured using a mechanical feeler 310, in particular along a line 312, which extends equidistant to the outer contour 302. From the image processing data sets and the mechanical feeler system 310, a conclusion can then be drawn about the three-dimensional course of the edge of the sheet metal board 300 by superimposing the data sets.

The mechanical feeler system can be a purely measuring or switching feeler system, or also an opto-tactile system, as that disclosed in EP 0 988 505 B1, the disclosure of which is expressly referenced.

According to the illustration in FIG. 4, the course of elevations of an edge of a sheet metal board 400 as the object is determined in principle analog to the exemplary embodiment of FIG. 3. Here, apart from an image processing sensor, a laser beam path (symbolized by dot 402), which is integrated in said sensor, is used instead of the mechanical feeler system 310 from FIG. 3. In this way it is possible during the scanning process to determine the outer contour 404 of the workpiece 400 using the image processing sensor and at the same time information in a perpendicular direction thereto using the laser sensor 402. The spatial position of the edge of the sheet metal board 100, i.e., its contour 104, is again determined by superimposing the sensor information of the sensor laser 402 and the image processing sensor. In this way it is likewise possible first to scan the outer contour with the help of the image processing system and then measure the third coordinate using the laser sensor 402, wherein, in accordance with the exemplary embodiment from FIG. 3, the measuring points are determined along a line 408 extending equidistant to the contour 404. It is also possible to accomplish the focusing of the image processing sensor in real time by means of the laser sensor.

1. Method for capturing and/or measuring capturing a contour of a workpiece by scanning by means of a coordinate measuring device while employing at least one first and at least one second sensor, wherein, by means of the at least one first sensor, first a contour of the workpiece in one plane is scanned, and then the information obtained from the scanning operation is used to determine the travel paths of the at least one second sensor.

2. Method pursuant to claim 1, wherein an image processing sensor is used as at least one sensor.

3. Method pursuant to claim 1, wherein a feeler measuring upon contact is used as at least one sensor.

4. Method pursuant to claim 1, wherein a touchless distance sensor is used as at least one sensor.

5. Method pursuant to claim 1, wherein a fiber-optic feeler is used as at least one of the sensors.

6. Method pursuant to claim 1, wherein at least one of the sensors is used to position at least one other sensor within its working area.

7. Method pursuant to claim 1, wherein at least one of the sensors is used to avoid a collision of further participating sensors.

8. Method pursuant to claim 1, wherein different illumination arrangements, such as incident light or transmitted light, are used for at least one image processing sensor.

9. Method pursuant to claim 1, wherein, when using an opto-tactile feeler with a feeler element, the scanning direction required for the feeler element correction is generated from the information of a further sensor.

10. Method pursuant to claim 1, wherein the scanning direction of one or the contact feeler required for the feeler element is generated from information of another sensor.

11. Method pursuant to claim 1, wherein at least one image processing sensor is focused on the basis of a measuring reading determined with a distance sensor.

12. Method pursuant to claim 1, wherein at least one image processing sensor is focused on the basis of a measuring reading determined with a contact feeler.

13. Method pursuant to claim 1, wherein a scanning operation occurs within one step, and wherein processing of the sensor information is performed on-line.

14. Method pursuant to claim 1, wherein the scanning operation occurs in several individual steps, and wherein processing of the sensor information does not occur in line with scanning.

15. Method pursuant to claim 1, wherein the third coordinate to the contour scanned in the plane or a contour offset thereto is captured using a second sensor.

16. Method pursuant to claim 1, wherein a scanning plane is defined a priori and a distance sensor is displaced in the plane such that the distance value is a constant, wherein the method is not performed in the direction of the axis of the sensor.

17. Method pursuant to claim 1, wherein the scanning operation or operations are performed on one or more coordinate measuring devices.

18. Method pursuant to claim 1, wherein at least one of the sensors is an image processing sensor, in which the magnification is modified.

19. Method pursuant to claim 1, wherein a combination of sensors is used, such as image processing with laser distance sensor and/or image processing with contact feeler and/or image processing with fiber feeler and/or opto-tactile feeler and/or image processing with image processing in various resolutions and/or image processing with various views and/or laser with contact feeler and/or laser with fiber feeler such as opto-tactile feeler and/or contact feeler with fiber feeler such as opto-tactile feeler and/or contact feeler with contact feeler with various feeler elements or sensitivity levels and/or fiber feeler with fiber feeler with various feeler elements or sensitivity levels is used.

20. Method pursuant to claim 1, wherein the contour is measured in an opto-tactile manner by means of a feeler that is moved along said contour and an optical sensor assigned thereto and that the movement of the feeler along the contour is controlled by means of an image processing sensor.

21. Method pursuant to claim 20, wherein both the measuring readings of an opto-tactile feeler and those of an image processing sensor are used to measure the workpiece contour by scanning.

22. Method pursuant to claim 1, wherein the measuring operation is performed on a coordinate measuring device.

23. Method pursuant to claim 1, wherein the regulation of the scanning operation of the coordinate measuring device is implemented via the image processing sensor and the capturing of the measuring points via an opto-tactile feeler.

24. Method pursuant to claim 1, wherein the same image processing optics and/or camera and/or electronics are used for tracing the contour with the image processing sensor and for measuring the measuring points with the opto-tactile feeler.

25. Method pursuant to claim 1, wherein a separate optical beam path is used for tracing the contour with the image processing sensor.

26. Method pursuant to claim 1, wherein the image processing sensor and opto-tactile feeler are integrated such in an optical path that for both sensors adjusted different magnification levels are achieved.

27. Method pursuant to claim 1, wherein tracing of the contour with the image processing sensor occurs in transmitted light or incident light, wherein simultaneously the measurement with the opto-tactile sensor is performed alternatively in transmitted light or incident light.

28. Method pursuant to claim 1, wherein a scanning direction of the opto-tactile feeler required for a feeler sphere correction is generated from the image processing contour tracing.

29. Method pursuant to claim 1, wherein the image processing windows used for contour tracing overlap.

30. Method pursuant to claim 1, wherein contour tracing is performed using an image processing scanner and, at a previously defined distance to the contour traced in this way, the height of the measurement object is captured using another distance sensor.

31. Method pursuant to claim 1, wherein the image processing sensors are focused on the basis of a measuring reading determined with a distance sensor.

32. Method pursuant to claim 1, wherein a laser distance sensor is used as the distance sensor.

33. Method pursuant to claim 1, wherein the laser distance sensor is integrated in the optical beam path of the image processing sensor.

34. Method for scanning workpiece contrours, wherein for the purpose of scanning the contour, a distance sensor is used, a scanning plane is defined in advance in workpiece coordinates, and the distance sensor travels in said plane such that the distance value is a constant, wherein the movement of the distance sensor does not occur in the direction of the axis of the sensor.
